(19) United States
(12) Patent Application Publication
(10) Pub. No.: US 2015/0120637 A1
(43) Pub. Date: Apr. 30, 2015

(54) APPARATUS AND METHOD FOR ANALYZING BOTTLENECKS IN DATA DISTRIBUTED DATA PROCESSING SYSTEM

(71) Applicant: SAMSUNG ELECTRONICS CO., LTD., Suwon-Si (KR)

(72) Inventors: HYEON-SANG EOM, SEOUL (KR); IN-SOON JO, SEOUL (KR); MIN-YOUNG SUNG, SEOUL (KR); MYUNG-JUNE JUNG, SUWON-SI (KR); JU-PYUNG LEE, SUWON-SI (KR)

(73) Assignee: SEOUL NATIONAL UNIVERSITY R&DB FOUNDATION, SEOUL (KR)

(21) Appl. No.: 14/488,147

(22) Filed: Sep. 16, 2014

(30) Foreign Application Priority Data
Oct. 30, 2013 (KR) 10-2013-0130336

(51) Int. Cl. G06F 9/52; G06N 5/02

(52) U.S. Cl. CPC G06F 9/524; G06N 5/025
USPC 706/47

(57) ABSTRACT

An apparatus and method for analyzing bottlenecks in a data distributed processing system. The apparatus includes a learning unit mining and learning bottleneck-feature association rules based on hardware information related to a bottleneck node, job configuration information related to a bottleneck causing job, and/or I/O information regarding a bottleneck causing task. Based on the bottleneck-feature association rules, a bottleneck cause analyzing unit detects a bottleneck node among multiple nodes performing tasks in the data distributed processing system, and analyzes the bottleneck cause.

### CROSS-REFERENCE TO RELATED APPLICATION

This application claims priority under 35 U.S.C. §119 from Korean Patent Application No. 10-2013-0130336 filed on Oct. 30, 2013, the subject matter of which is hereby incorporated by reference.

### BACKGROUND

The inventive concept relates to data distributed processing technology, and more particularly to apparatuses and methods for analyzing bottlenecks in a data distributed processing system.

Recent advances in internet technology have greatly expanded the availability of, and access to very large data sets that are typically stored in a distributed manner. Indeed, many internet service providers, including certain portal companies, have sought to enhance their market competitiveness by offering capabilities that extract meaningful information from very large data sets. These very large data sets include data collected at very high speeds from many different sources. The timely extraction of meaningful information from such large data sets is a highly valued service to many users.

Accordingly, a great deal of contemporary research has been directed to large-capacity data processing technologies, and more specifically, to certain job distributed parallel processing technologies. Such technologies allow for cost effective data processing using large-scale processing clusters.

For example, MapReduce is a programming model developed by Google, Inc. for processing large data sets using a parallel distributed algorithm on a cluster. Distributed parallel processing systems based on the MapReduce model also include the Hadoop MapReduce system developed by Apache Software Foundation.

Any particular MapReduce job generally requires large-capacity data processing. In order to accomplish such large-capacity data processing, a large amount of computational resources are required to complete the job in a reasonable time period. In order to obtain the necessary computational resources, the MapReduce job is divided into multiple executable tasks which are then respectively distributed over an assembly of computational resources. Unfortunately, this array of executable tasks are often logically or computationally dependent one upon the other. For example, a Task B may require a computationally derived output from a Task A and therefore may not be completed until Task A is completed. Further assuming in this example that the execution of Tasks C, D and E are all dependent upon completion of Task B, one may readily appreciate that Task A and also Task B are “bottlenecked tasks.”

From this simple example, and recognizing the complexity of contemporary, data distributed, parallel processing methodologies, it is not hard to appreciate the need for an apparatus and/or method for prospectively identifying possible bottlenecks.

### SUMMARY

Embodiments of the inventive concept provide apparatuses and methods that are capable of analyzing bottlenecks in a data distributed processing system.

According to an aspect of the inventive concept, there is provided an apparatus for analyzing bottlenecks in a data distributed processing system. The apparatus includes; a learning unit configured to mine feature information to learn bottleneck-feature association rules, wherein the feature information comprises at least one of hardware information related to a bottleneck node, job configuration information related to a bottleneck causing job, and input/output (I/O) information related to a bottleneck causing task, and a bottleneck cause analyzing unit configured to detect a bottleneck node among multiple nodes executing tasks in the data distributed processing system using the bottleneck-feature association rules, and further configured to analyze a bottleneck cause for the bottleneck node.

According to another aspect of the inventive concept, there is provided a method for analyzing bottlenecks in a data distributed processing system. The method includes; mining accumulated feature information to learn bottleneck-feature association rules, wherein the feature information includes at least one of hardware information related to a bottleneck node, job configuration information related to a bottleneck causing job, and input/output (I/O) information related to a bottleneck causing task, detecting a bottleneck node among multiple nodes performing tasks in the data distributed processing system in response to the bottleneck-feature association rules, and analyzing a bottleneck cause for the bottleneck node.

### BRIEF DESCRIPTION OF THE DRAWINGS

The above and other features and advantages of the inventive concept will become more apparent upon consideration of certain embodiments with reference to the attached drawings in which:

FIG. 1 is a general block diagram illustrating a bottleneck analyzing apparatus for a data distributed processing system according to an embodiment of the inventive concept;

FIG. 2 is a block diagram illustrating a bottleneck analyzing apparatus for a data distributed processing system according to another embodiment of the inventive concept;

FIG. 3 is a resource table illustrating examples of mining and learning bottleneck-feature association rules;

FIG. 4 is a conceptual diagram illustrating an example of output data depending on input data of a bottleneck analyzing apparatus according to an embodiment of the inventive concept;

FIG. 5, inclusive of FIGS. 5A, 5B and 5C, illustrates respective data distributed processing systems according to embodiments of the inventive concept; and

FIG. 6 is a flowchart summarizing in one example a method for analyzing bottlenecks in a data distributed processing system according to an embodiment of the inventive concept.

### DETAILED DESCRIPTION

Advantages and features of the inventive concept and methods of accomplishing same will be more readily understood by reference to the following detailed description of embodiments together with the accompanying drawings. The inventive concept may, however, be embodied in many different forms and should not be construed as being limited to only the illustrated embodiments. Rather, these embodiments are provided so that this disclosure will be thorough and complete and will fully convey the concept of the inventive concept to those skilled in the art. Throughout the written description and drawings, like reference number and labels are used to denote like or similar elements.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

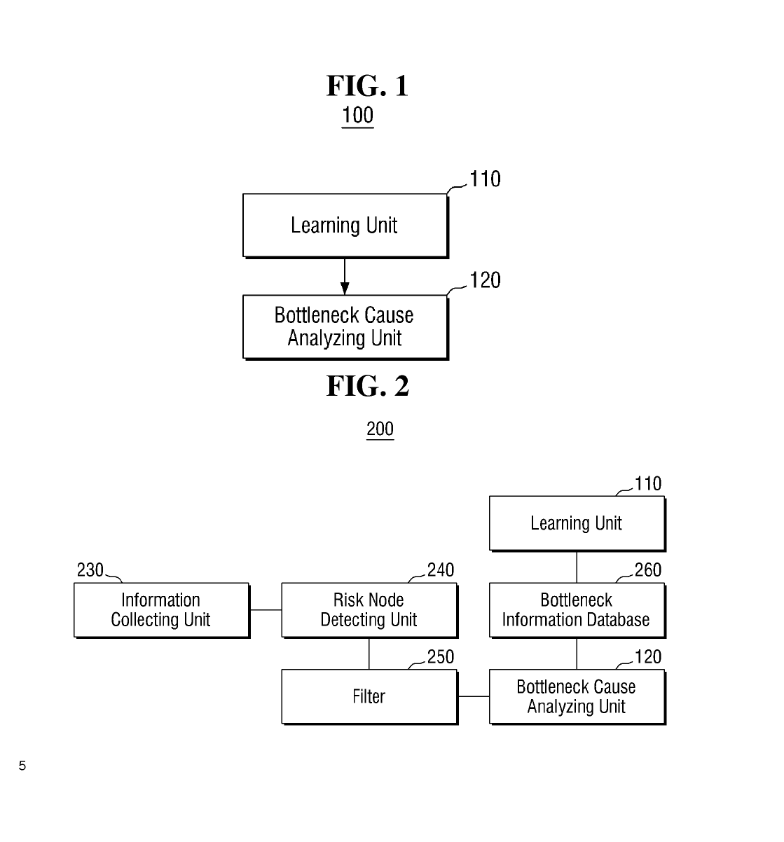

FIG. 1 is a general block diagram of a bottleneck analyzing apparatus for a data distributed processing system according to an embodiment of the inventive concept. Here, the data distributed processing system is an execution system capable of dividing a “job” into multiple executable “tasks”, and further capable of allocating the multiple tasks over a large number of “nodes”, wherein each node is an assembly of computational resources. For contextual reference, a MapReduce-based data distributed processing system is one type of data distributed processing system contemplated by various embodiments of the inventive concept, but the scope of the inventive concept is not limited to only MapReduce-based data distributed processing systems.

Referring to FIG. 1, the bottleneck analyzing apparatus 100 for the data distributed processing system generally comprises a learning unit 110 and a bottleneck cause analyzing unit 120.

The learning unit 110 may be used to collect “feature information” including hardware information related to bottleneck nodes (e.g., CPU speed, number of CPUs, memory capacity, disk capacity, network speed, etc.), job configuration information related to bottleneck causing jobs (e.g., configuration set(s) required to execute a task, input data size, input memory buffer size, I/O buffer size, map task size, number of map slots per node, number of map tasks, number of reduce tasks, task execution time—such as setup, map, shuffle, and reduce/total times, etc.), input/output (I/O) information related to bottleneck causing tasks (e.g., number of I/O events, number of read/write events, total number of bytes requested by all events, average number of bytes per event, average difference of sector numbers requested by consecutive events, elapsed time between first and last I/O requests, average/minimum/maximum completion time of all events, average/minimum/maximum completion time of read events, average/minimum/maximum completion time of write events, etc.), and so on. Upon collection of sufficient feature information, the learning unit 110 may be used to mine and learn corresponding bottleneck-feature association rules. During this mining and learning procedure, certain relationships between reoccurring feature information and corresponding bottlenecks may be identified.

Where the data distributed parallel processing system is a Hadoop MapReduce-based data distributed parallel processing system, the job configuration information may include Hadoop configuration information or MapReduce information associated with a configuration of a Hadoop cluster for a MapReduce job.

According to certain embodiments of the inventive concept, the learning unit 110 may mine and learn bottleneck-feature association rules using one or more conventionally understood machine learning algorithm(s), such as naive Bayesian, artificial neural network, decision tree, Gaussian process regression, k-nearest neighbor, support vector machines (SVMs), k-means, Apriori, AdaBoost, CART, etc. Analogous emerging machine learning algorithms might alternately or additionally be used by the learning unit 110.

The bottleneck cause analyzing unit 120 of FIG. 1 may be used to detect a bottleneck node among the multiple nodes executing data distributed processing based on the bottleneck-feature association rules provided by the learning unit 110 in order to analyze a bottleneck cause. According to certain embodiments of the inventive concept, the bottleneck cause analyzing unit 120 may analyze a bottleneck cause by classifying the bottleneck cause into node related instance, job configuration related instance, and I/O related instance, for example.

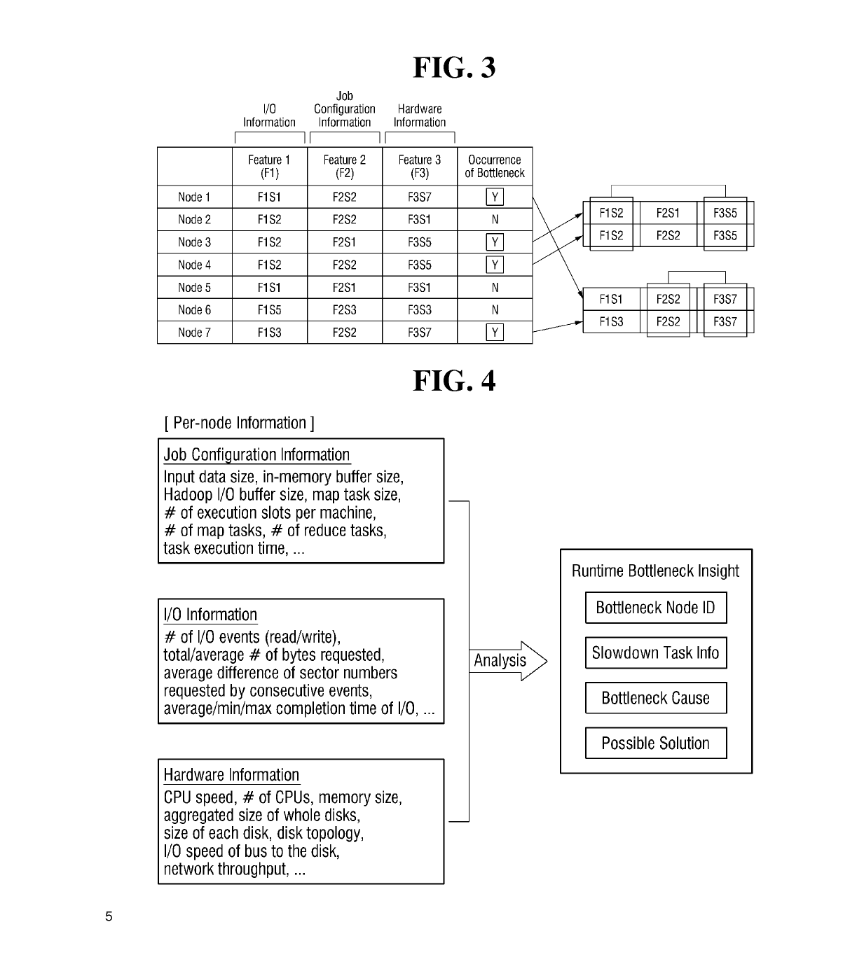

FIG. 2 is a block diagram illustrating a bottleneck analyzing apparatus for a data distributed processing system according to another embodiment of the inventive concept.

Referring to FIG. 2, a bottleneck analyzing apparatus 200 comprises an information collecting unit 230, a risk node detecting unit 240, a filter 250 and a bottleneck information database 260 in addition to the learning unit 110 and bottleneck cause analyzing unit 120 of FIG. 1.

The information collecting unit 230 may be used to collect feature information, where the feature information includes hardware information, job configuration information and I/O information, as described by way of various examples listed above. Some or all of the feature information collected by the information collecting unit 230 may be provided to the learning unit 110.

The risk node detecting unit 240 may be used to detect a “risk node” having a bottleneck occurrence probability based on the feature information collected by the information collecting unit 230. For example, the risk node detecting unit 240 may determine a bottleneck occurrence probability of each node currently executing a task based on the I/O information of the task collected by the information collecting unit 230, and may detect the risk node having a bottleneck probability based on the determined bottleneck occurrence probability.

Alternatively, the risk node detecting unit 240 may be used to detect a risk node having a bottleneck occurrence probability based on the information collected from the information collecting unit 230 and the bottleneck-feature association rules provided by the learning unit 110. For example, the risk node detecting unit 240 may determine whether the feature information for each node included in the information collected from the information collecting unit 230 is identical with the information regarding a feature associated with a bottleneck according to the bottleneck-feature association rules, and may determine that a node related to at least one instance of collected feature information is a risk node.

The filter 250 may be used to filter the feature information collected by the information collecting unit 230 to allow only relevant feature information to be used by the bottleneck analyzing apparatus 200 in view of current performance requirements and/or data distributed processing system conditions.

The bottleneck information database 260 may be used to store feature information and/or bottleneck-feature association rules provided by the learning unit 120.

FIG. 3 illustrates an example of mining and learning bottleneck-feature association rules. Here, FnSn denotes feature information, meaning that a value of a feature Fn is Sn. In addition, for the sake of convenient explanation, assumptions are made that the data distributed processing system includes 7 nodes, and each of I/O information, job configuration information and hardware information includes only the information regarding a feature.

Referring to FIGS. 1, 2 and 3, the learning unit 110 is now assumed to have collected feature information F1, F2 and F3 for bottleneck nodes 1, 3, 4 and 7. In this regard, feature information in its various types may be understood as data of various forms indicting some relevant information. Some feature information may be time sensitive or time variable. Other feature information may be fixed. Some feature information may include only a single flag. Other feature information may include a large data file. Upon receiving the feature information, the learning unit 110 may be used to mine the feature information and learn related bottleneck-feature association rules.

Looking at FIG. 3, since the bottleneck nodes 1 and 7 have F2S2 and F3F7, the learning unit 110 determines that F2S2 and F3F7 are closely related to occurrence of bottlenecks. In addition, since the bottleneck nodes 3 and 4 have F1S2 and F3S5, the learning unit 110 determines that F1S2 and F3S5 are closely related to occurrence of bottlenecks. In this manner, the learning unit 110 may be used to learn the bottleneck-feature association rules.

FIG. 4 is a conceptual diagram illustrating an example of output data depending on input data as determined by the bottleneck analyzing apparatus 100 of FIG. 1.

Referring to FIG. 4, if the bottleneck analyzing apparatus 100 receives input data for each node, including job configuration information, I/O information and hardware information, the learning unit 110 mines and learns the bottleneck-feature association rules based on the input data during a preset period for learning. Once the learning of bottleneck-feature association rules is complete, the bottleneck cause analyzing unit 120 may be used to detect bottleneck node(s) using input data following the learning of the bottleneck-feature association rules. Thereafter, a bottleneck cause may be provided as part of the analysis result to a user. For example, the bottleneck analyzing apparatus 100 may provide an analysis result including: bottleneck node identities (ID), slowdown task information, bottleneck cause(s), and/or possible solution(s).

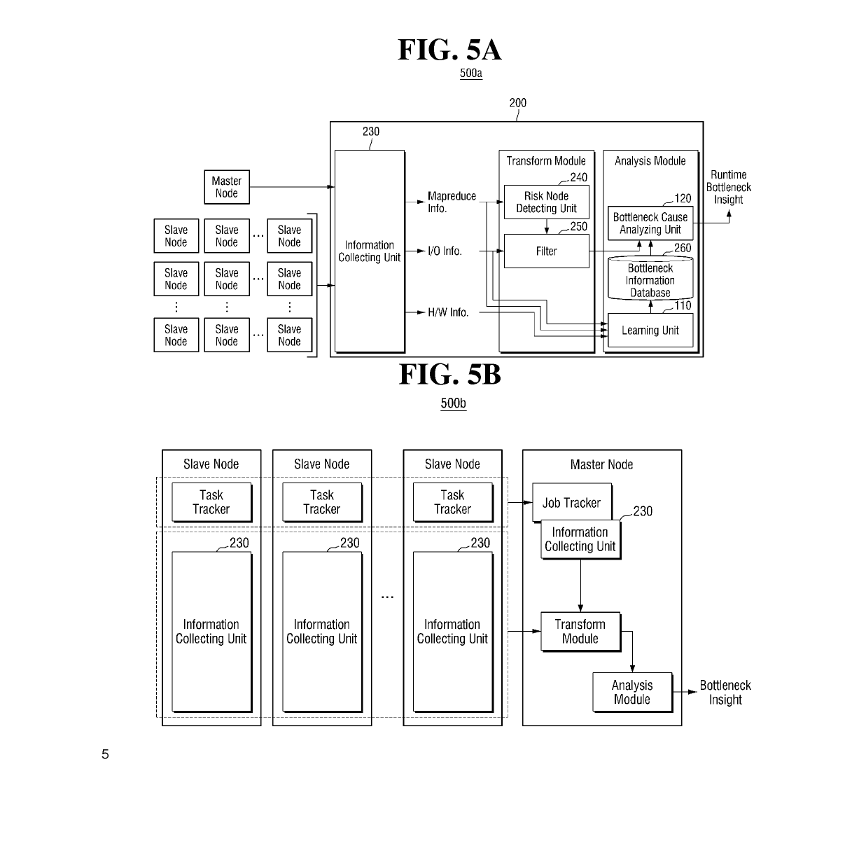

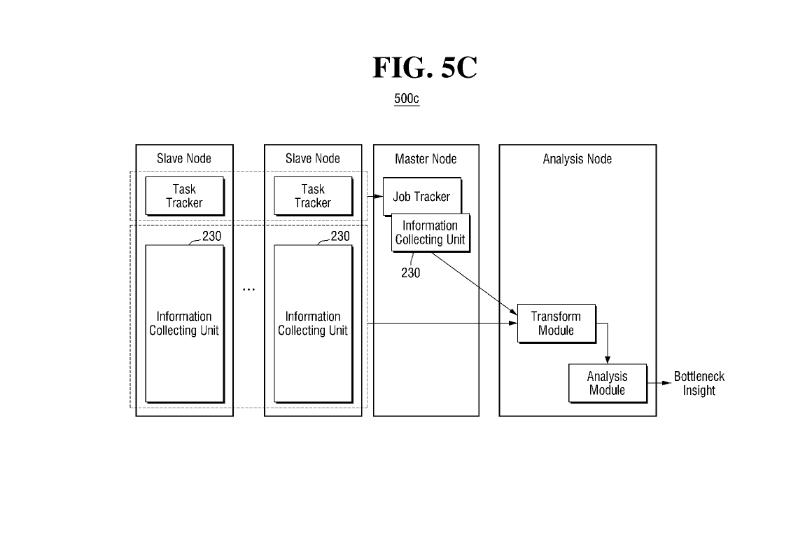

FIG. 5, inclusive of FIGS. 5A, 5B and 5C, illustrates various exemplary data distributed processing systems according to certain embodiments of the inventive concept.

FIG. 5A illustrates one structure for a data distributed processing system 500a in which the bottleneck analyzing apparatus 200 is implemented external to the relevant nodes, including (e.g.,) a master node and slave nodes. FIG. 5B illustrates another structure for a data distributed processing system 500b in which the information collecting unit 230 is incorporated in each slave node, while other constituent elements of the bottleneck analyzing apparatus 200 are incorporated in a master node. FIG. 5C illustrates yet another structure for a data distributed processing system 500c in which the information collecting unit 230 is incorporated in each slave node, while other constituent elements of the bottleneck analyzing apparatus 200 are implemented in separate (dedicated) analysis node(s).

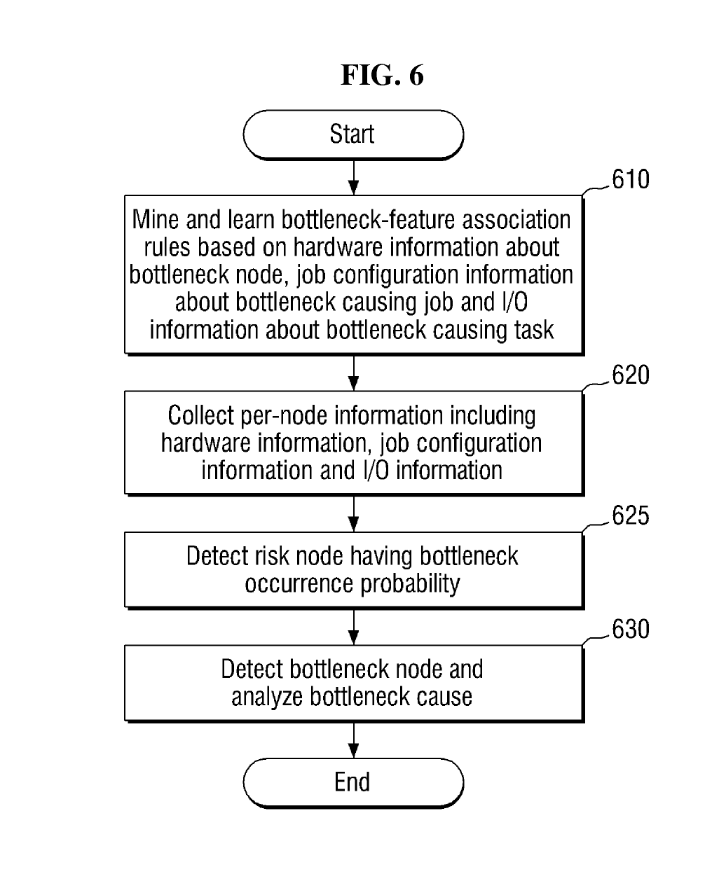

FIG. 6 is a flowchart summarizing in one example a method for analyzing bottlenecks in a data distributed processing system according to certain embodiments of the inventive concept.

Referring to FIG. 6, the method for analyzing bottlenecks in a data distributed processing system begins with the mining and learning of bottleneck-feature association rules based on hardware information of a bottleneck node, job configuration information of a bottleneck causing job and I/O information of a bottleneck causing task (step 610).

Thereafter, per-node information pieces, including hardware information, job configuration information and I/O information, are collected from each node currently executing a data distributed processing operation (step 620).

Next, among multiple nodes currently executing data distributed processing operations, a bottleneck node is detected based on the information collected in step 620 and the learned bottleneck-feature association rules, and a bottleneck cause is analyzed (step 630).

In some embodiments of the inventive concept, the method for analyzing bottlenecks may further include detecting a risk node having a bottleneck occurrence probability among the multiple nodes based on the information collected in step 620 (step 625).

In step 630, the risk node detected in step 625 is intensively observed and analyzed, thereby more rapidly detecting the bottleneck node and analyzing the bottleneck cause.

Certain embodiments of the inventive concept may be embodied, wholly or in part, as computer-readable code stored on computer-readable media. Such code may be variously implemented in programming or code segments to accomplish the functionality required by the inventive concept. The specific coding of such is deemed to be well within ordinary skill in the art. Various computer-readable recording media may take the form of a data storage device capable of storing data which may be read by a computational device, such as a computer. Examples of the computer-readable recording media include read-only memory (ROM), random-access memory (RAM), CD-ROMs, magnetic tapes, floppy disks, and optical data storage devices.

While the inventive concept has been particularly shown and described with reference to selected embodiments thereof, it will be understood by those of ordinary skill in the art that various changes in form and details may be made therein without departing from the scope of the following claims. It is therefore desired that the illustrated embodiments should be considered in all respects as illustrative and not restrictive.

What is claimed is:

1. An apparatus for analyzing bottlenecks in a data distributed processing system, the apparatus comprising:
a learning unit configured to mine feature information to learn bottleneck-feature association rules, wherein the feature information comprises at least one of hardware information related to a bottleneck node, job configuration information related to a bottleneck causing job, and input/output (I/O) information related to a bottleneck causing task; and
a bottleneck cause analyzing unit configured to detect a bottleneck node among multiple nodes executing tasks in the data distributed processing system using the bottleneck-feature association rules, and further configured to analyze a bottleneck cause for the bottleneck node.

2. The apparatus of claim 1, wherein the data distributed processing system is a MapReduce-based data distributed processing system.

3. The apparatus of claim 1, wherein the hardware information includes at least one of CPU speed, number of CPUs, memory capacity, disk capacity, and network speed.

4. The apparatus of claim 1, wherein the job configuration information includes at least one of input data size, input memory buffer size, I/O buffer size, map task size, number of map slots per node, number of map tasks, number of reduce tasks, and task execution time.

5. The apparatus of claim 4, wherein the task execution time includes at least one of setup time, map time, shuffle time, reduce time, and total time.

6. The apparatus of claim 1, wherein the I/O information includes at least one of number of I/O events, number of read/write events, total number of bytes requested by all events, average number of bytes per event, average difference of sector numbers requested by consecutive events, elapsed time between first and last I/O requests, average/minimum/maximum completion time of all events, average/minimum/maximum completion time of read events, and average/minimum/maximum completion time of write events.

7. The apparatus of claim 1, wherein the learning unit is configured to learn the bottleneck-feature association rules using at least one machine learning algorithm including naive Bayesian, artificial neural network, decision tree, Gaussian process regression, k-nearest neighbor, and support vector machine (SVM).

8. The apparatus of claim 1, further comprising:
an information collecting unit configured to collect per-node information from each node executing a task in the data distributed processing system, wherein the per-node information includes at least one of the hardware information, job configuration information and I/O information.

9. The apparatus of claim 8, further comprising:
a risk node detecting unit configured to detect a risk node having a bottleneck occurrence probability among the multiple nodes based on the per-node information collected by the information collecting unit.

10. The apparatus of claim 9, further comprising:
a filter that selectively provides to the bottleneck cause analyzing unit risk node information provided by the risk node detecting unit and per-node information provided by the information collecting unit.

11. A method for analyzing bottlenecks in a data distributed processing system, the method comprising:
mining accumulated feature information to learn bottleneck-feature association rules, wherein the feature information includes at least one of hardware information related to a bottleneck node, job configuration information related to a bottleneck causing job, and input/output (I/O) information related to a bottleneck causing task;
detecting a bottleneck node among multiple nodes performing tasks in the data distributed processing system in response to the bottleneck-feature association rules; and
analyzing a bottleneck cause for the bottleneck node.

12. The method of claim 11, wherein the data distributed processing system is a MapReduce-based data distributed processing system.

13. The method of claim 11, wherein the hardware information includes at least one of CPU speed, number of CPUs, memory capacity, disk capacity, and network speed.

14. The method of claim 11, wherein the job configuration information includes at least one of input data size, input memory buffer size, I/O buffer size, map task size, number of map slots per node, number of map tasks, number of reduce tasks, and task execution time.

15. The method of claim 11, wherein the I/O information includes at least one of number of I/O events, number of read/write events, total number of bytes requested by all events, average number of bytes per event, average difference of sector numbers requested by consecutive events, elapsed time between first and last I/O requests, average/minimum/maximum completion time of all events, average/minimum/maximum completion time of read events, and average/minimum/maximum completion time of write events.

16. The method of claim 11, wherein the learning of the bottleneck-feature associated rules includes using at least one machine learning algorithm, including naive Bayesian, artificial neural network, decision tree, Gaussian process regression, k-nearest neighbor, and support vector machine (SVM).

17. The method of claim 11, further comprising:
collecting per-node information for each node executing a task in the data distributed processing system to generate collection information, wherein the per-node information includes the hardware information, job configuration information and I/O information.

18. The method of claim 17, further comprising:
detecting a risk node having a bottleneck occurrence probability from among the multiple nodes executing a task in the data distributed processing system based on the collected information to generate risk node information.

19. The method of claim 18, further comprising:
filtering the collected information and the risk node information to generate filtered information; and
providing the filtered information to the bottleneck cause analyzing unit.

20. The method of claim 19, further comprising:
storing the bottleneck-feature information association rules in a bottleneck information database; and
providing the bottleneck-feature information association rules to the bottleneck cause analyzing unit from the bottleneck information database.
